(19) United States
(12) Patent Application Publication
(10) Pub. No.: US 2021/0289760 A1
(43) Pub. Date: Sep. 23, 2021

(54) TRAP LIFTER

(71) Applicant: University of Louisiana at Lafayette, Lafayette, LA (US)

(72) Inventor: Erika Jane Louviere, Loreauville, LA (US)

(21) Appl. No.: 17/205,690

(22) Filed: Mar. 18, 2021

Related U.S. Application Data
(60) Provisional application No. 62/992,198, filed on Mar. 20, 2020.

(51) Int. Cl. A01K 69/08

(52) U.S. Cl. CPC A01K 69/08

(57) ABSTRACT

A trap lifter is described here in comprising a slider mounted to a mount at one end through a hinge and a lifter tube at the other end. The slider is preferably in telescopic communication with the lifter tube. The lifter tube is connected with a hinge connector to a connector piece with a hook at the end. When the mount is secured to the side of a boat, it allows the user to hook a trap and lift the trap without needing to lean over the edge of the boat.

### CROSS REFERENCE TO RELATED APPLICATIONS

This application claims priority to U.S. Application No. 62/992,198 entitled “Trap Lifter” and filed on Mar. 20, 2020.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Trap Lifter, which may be embodied in various forms. It is to be understood that in some instances, various aspects of the invention may be shown exaggerated or enlarged to facilitate an understanding of the invention. Therefore the drawings may not be to scale.

FIG. 1 is an assembly schematic of one embodiment of the Trap Lifter.

FIG. 2 is a schematic showing the various rotation and telescopic positions of the Trap Lifter.

FIG. 3 is a schematic of one embodiment of the trap lifter tube.

FIG. 4 is a schematic of one embodiment of the trap lifter slider.

FIG. 5 is a schematic of one embodiment of trap lifter hook.

FIG. 6 is a schematic of one embodiment of the trap lifter mount.

FIG. 7 is a chart of the materials, dimensions, and weights for aluminum construction.

FIG. 8 is a chart of the materials, dimensions, and weights for steel construction.

FIG. 9 is a chart of the materials, dimensions, and weights for stainless steel construction.

### BACKGROUND

Crawfish farming is a prevalent occupation throughout Louisiana and other southern, marshy regions of the U.Ss. The harvesting process is strenuous. The repetitive motions of leaning over to grab the trap, picking up the trap, dumping the trap, baiting the trap, and setting the trap back in the water all happen in less than thirty seconds. To produce enough crawfish to go to market, a farmer may perform this sequence of tasks over and over for up to twelve hours a day on three to four days a week. Over time this stress on the farmers' bodies leads to pain in their backs, arms, and shoulders. These ailments are considered musculoskeletal symptoms, (“MSS”).

Musculoskeletal symptoms related to crawfish farming include shoulder, neck, upper back, elbow, lower back, wrist-hand, hip, knees, and feet. Aging farmers are at a higher risk for these. Along with these symptoms comes other issues like psychological, social, and financial burdens. As these farmers age and their ability to perform their job diminishes due to the degeneration of their musculoskeletal systems, it affects them psychologically. They feel they can no longer provide for their families like they should. This psychological affect in turn leads to social issues because they may start to cut themselves off from others due to embarrassment of not being able to provide for their families The lack of performance leads to financial issues as well because these farmers may have to hire help reducing their profit margins. All these lead to higher risks for injuries while performing their jobs.

The economic cost of these musculoskeletal symptoms has affected our economy since the 1960s. The economic cost not only includes the monetary value of medical expenses, but also the missed work costs for employers and employees. This economic cost affects everyone. Musculoskeletal symptoms start affecting workers at midlife. Often rural farmers do not seek medical help for their symptoms. With these symptoms going undisclosed and not tended to, the resulting disabilities are worse than they should have been.

MSS injuries resulting in lost workdays in Louisiana in the years from 2003-2017, compared to the number of crawfish farmers, acres of ponds, and dollars harvested from 2003-2017 was calculated to show the potential lost dollars for both 40 and 90 day crawfish seasons for 2-7 missed harvesting days per season. Using the information, the potential loss dollars are shown much greater for less harvesting days during the season. The more harvesting days a farmer has the lower his potential lost dollars are.

Moreover, for solo crawfish farmers missed workdays means dollars lost because most farms could be harvested by the farmer alone. Annual reports of crawfish acreage and number of farmers in Louisiana published by Louisiana State University Agriculture Center show that most farmers can harvest their acreage alone with the right equipment (Center). As of 2008, 98% of crawfish farmers used boats instead of walking. The best equipment is operated with foot pedals connected to a hydraulic pump and motor that propels a metal wheel with cleats which dig into the mud either pushing or pulling the boat thru the pond leaving the farmers hands free to harvest the traps.

Devices have been designed to make the crawfish harvesting process more efficient and less strenuous on the farmers. Some of these devices that do not require traps or bait show great potential but are not economical and have technical problems that need to be addressed. There are several prior art references related to crawfish harvesting systems, but none of them incorporate the current equipment being used by crawfish farmers. The development of a device that is an accessory to the farmers' current equipment that is easy to install and operate would be more economical than purchasing a whole new harvesting system.

Additionally, lowering any musculoskeletal symptoms will also lower risks of injuries while harvesting crawfish for young and older farmers. By minimizing musculoskeletal symptoms with the use of this mechanism the impact on the farmers' psychological health will be reduced. The social and economic health of the farmers will benefit as well.

This invention provides a method for harvesting crawfish that comprises a tool to be mounted to the crawfish boat that will raise the trap out of the water for the farmers, thereby eliminating strain on the farmers' bodies. The invention is easy to operate minimizing the learning curve so farmers can quickly use the mechanism efficiently. The invention also provides a quick return on investment, including a reduction in physical symptoms that is readily perceived.

The invention also provides simple assembly, so that the farmers do not have to non-trivially modify their existing equipment. Simple mechanical parts with no hydraulic, pneumatic, or electronic components also minimizes break down or mechanical failure issues. The mechanism also mounts and operates in a way that is not intrusive to the farmers' work of emptying the trap, rebaiting it, and replacing it into the water.

Moreover, the material used in the invention is light weight to avoid adding extra weight (extra weight in the boat would cause, inter alia, deeper ruts in the ponds and in turn cost the farmer more money after the season to rework his pond). The material also avoids damage to the traps.

### DETAILED DESCRIPTION

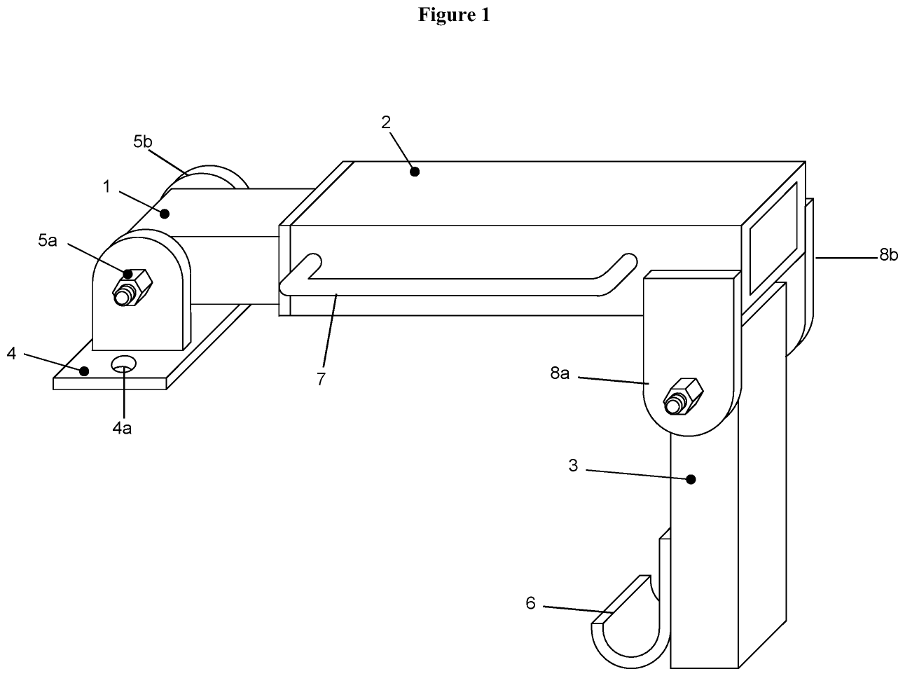

In an exemplary embodiment of the Trap Lifter shown in FIG. 1, the inventive design comprises a structural piece of J channel 6, two sizes of square tubing 1, 2, a third piece of square tubing for the hook 3, a mounting plate 4, two bolts with nuts 5a,b, a J channel 6, and round bar for the handle 7.

As shown in FIG. 1, the trap lifter slider comprises a piece of square tubing 1. The tubing is desirably dimensioned so as to be capable of telescopically connecting to the trap lifter tube 2. The trap lifter slider also comprises two plates 8a,b which connect to the trap lifter hook 6 through a piece of square tubing 3. The plates 8a,b are secured using any suitable means, including a hex bolt and hex nut. The plates 8a,b may be any suitable shape but are shown in FIG. 1 as rectangle with a semi-circle positioned at one end.

In one embodiment, the trap lifter slider is made of aluminum. Although any suitable, lightweight, durable, corrosive resistant material may be used.

The trap lifter slider also may comprise at least one rounded bar 7. The rounded bar 7 may be any suitable shape or size to facilitate grip by a human operator.

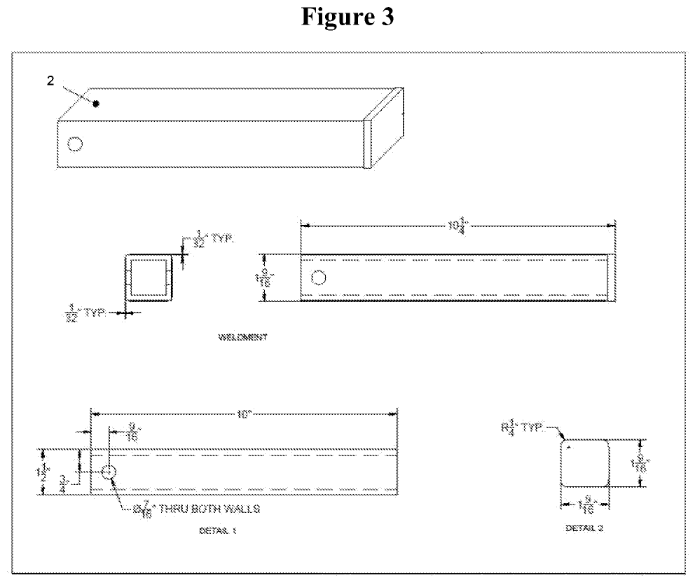

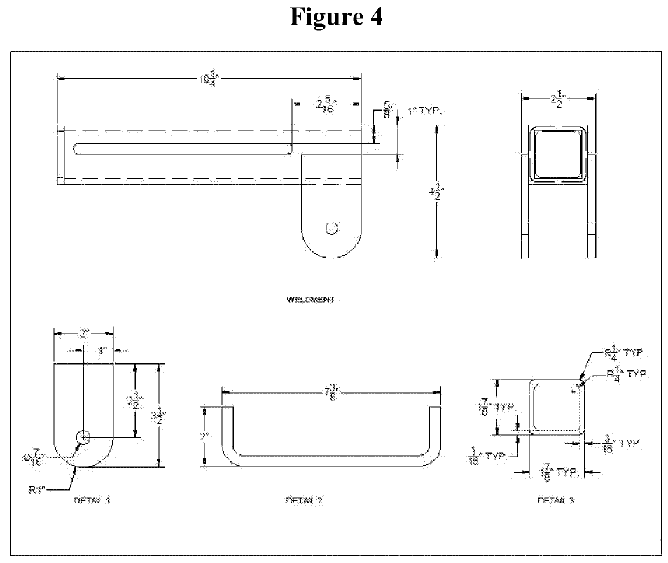

The trap lifter tube 2 comprises a square piece of tubing. The tubing may be made of aluminum; however, any suitable material may be used. The trip lifter slider 1 is sized to be able to fit inside the trap lifter tube 2. FIG. 3 presents suitable dimensions for the trap lifter tube. FIG. 4 provides suitable dimensions for the trap lifter slider.

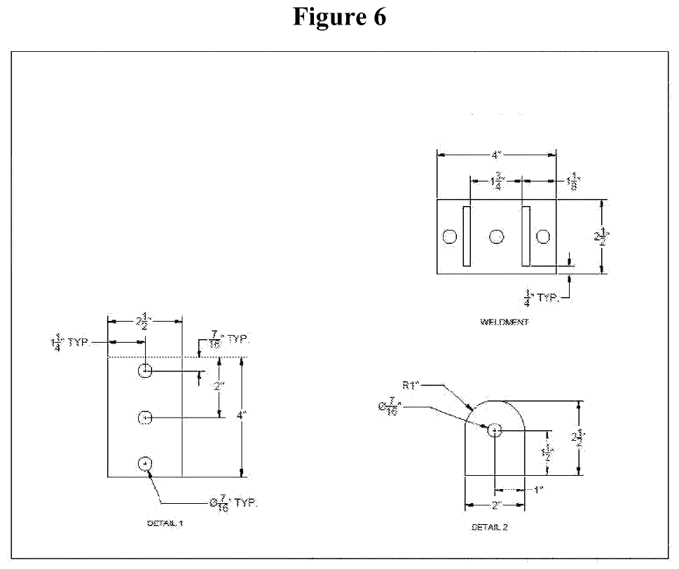

The trap lifter mount, in one embodiment, comprises two rounded plates 5a,b and one flat, plate 4 held together using any suitable method. One such suitable method being welding. More specifically, the trap lifter slider 1 is connected to two support plates 5a,b opposite the trap lifter tube 2. This connection may be though a hex bolt and hex nut, or any other suitable connecting means. The support plates 5a,b are connected at the other end to the trap lifter mount 4. FIG. 6 provides suitable dimensions for the support plates 5a,b and lifter mount 4. In other embodiments, the trap lifter tube 2 is connected to the trap lifter mount 4 in any suitable manner that allows for 180-degree rotation of the trap lifter tube in a hinge-like manner.

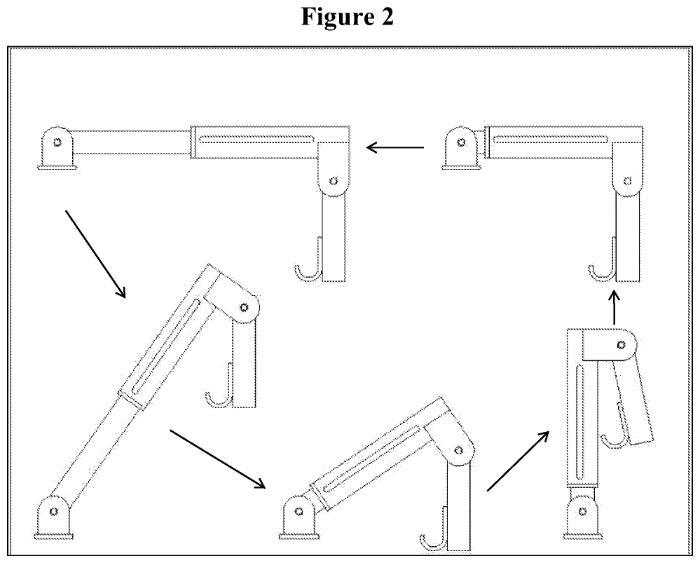

FIG. 2 provides various degrees of rotation of the trap lifter slider 1 and tube 2 as well as the telescopic nature of the trap lifter slider 1 and tube 2. FIG. 2 specifically shows the various ways in which the trap lifter slider 1 and tube 2 can be configured and moved in and out of position. Any combination or order of the manipulations is possible.

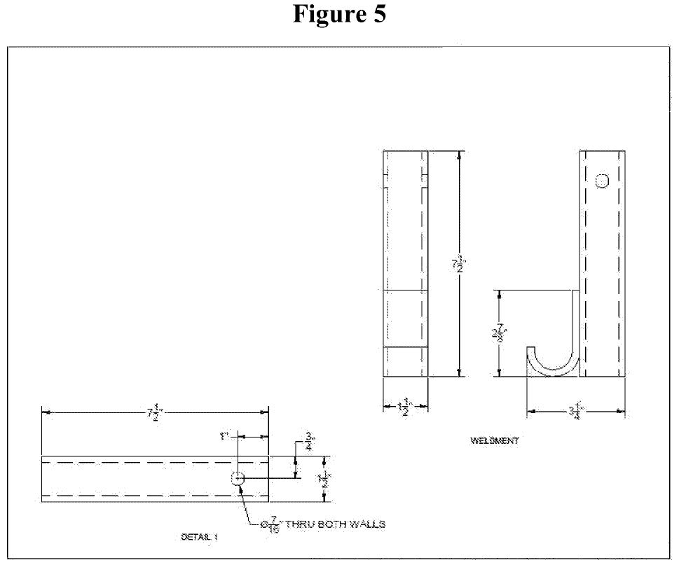

A trap lifter hook is located at the end of the trap lifter tube 2 opposite trap lifter mount 4. The trap lifter hook comprises a third square tubing 3 and a structural piece of J channel 6. The structural piece of J channel 6 is shaped and sized so as to allow the trap to catch on to the J channel 6. FIG. 5 depicts a typical embodiment of the trap lifter hook with suitable dimensions.

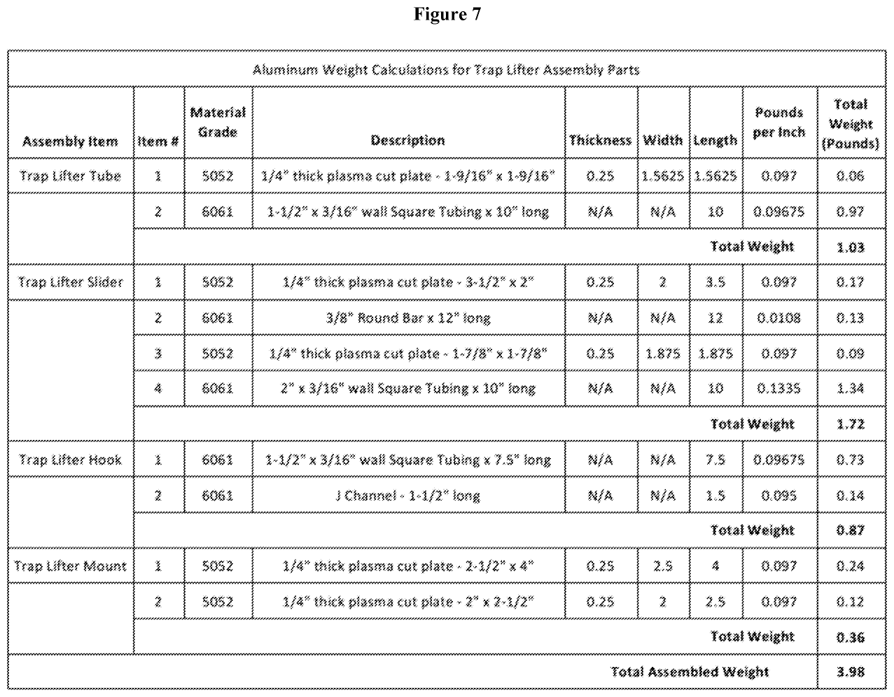

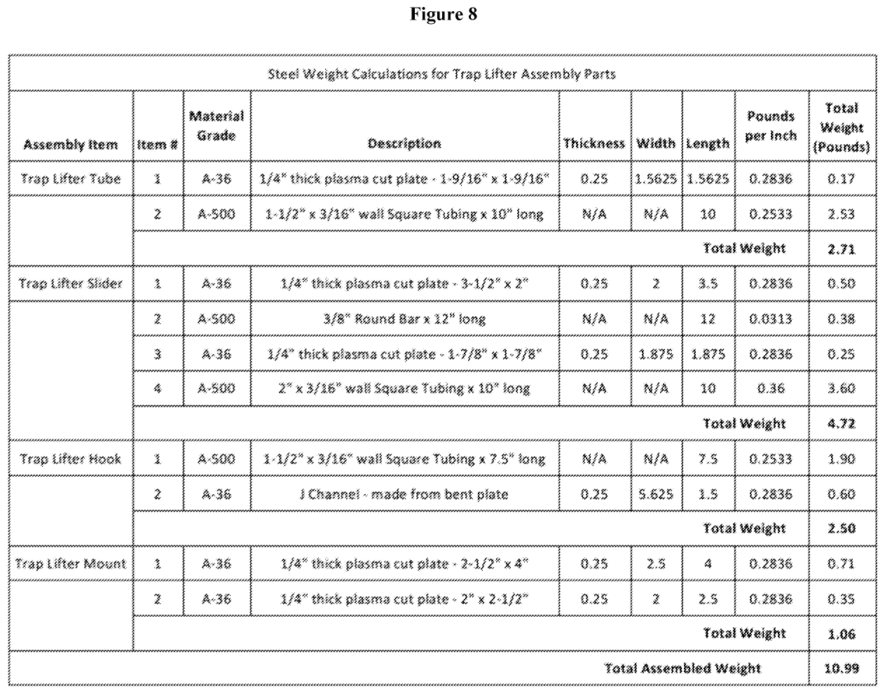

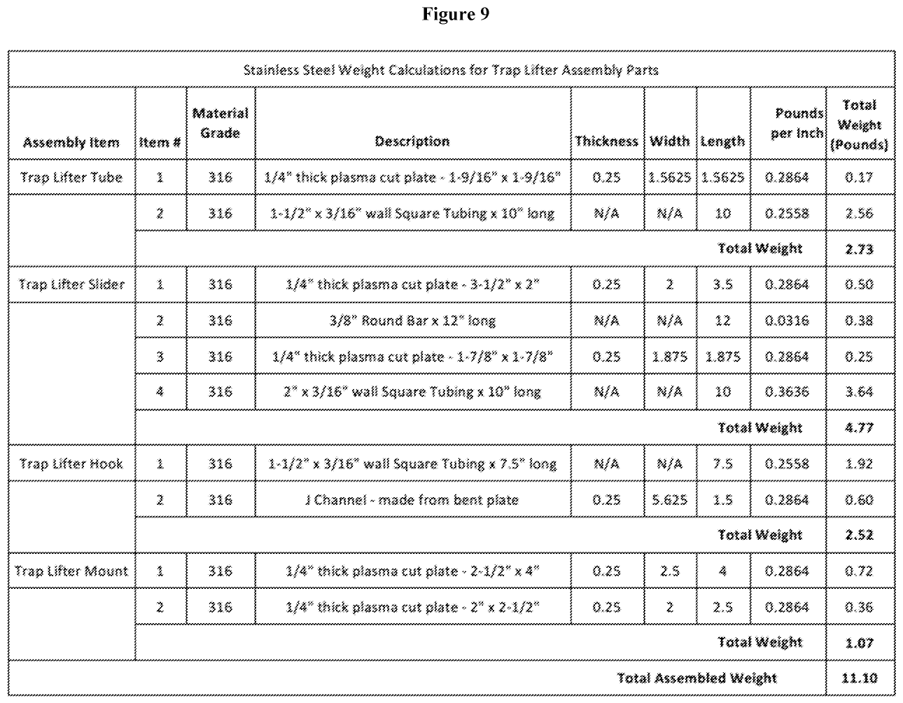

Suitable dimensions have been presented above. Moreover, FIGS. 7-9 provide other suitable dimensions based on the materials used. FIG. 7 provides the weights and dimensions of an aluminum assembly. FIG. 8 provides the weights and dimensions of a steel assembly. And FIG. 9 provides the weights and dimensions of a stainless-steel assembly.

Using aluminum to construct the mechanism is a preferred embodiment. Since the Trap Lifter will be used in a wet environment, aluminum will not need to be coated to protect it from the elements.

To install the Trap Lifter to a boat, in one embodiment, the operator drills three holes into the gunnel using the mounting plate 4 as a template for hole locations. As shown in FIG. 1, the mounting plate comprises drilling hole 4a (and not pictured, 4b). Any number of drilling holes may be used in order to secure the mounting plate 4. The drilling may be performed wherever the user chooses based on convenience.

A desirable location for the trap lifter is closest to the harvester attached to the gunnel (or side rail) of the boat. It is intended to act as an extension of the users' arms and hands. In other embodiments, the trap lifter is located on the sorting tray or the floor of the boat. In other embodiments still, the trap lifter may be located in any suitable location on the boat.

The user then attaches the trap lifter mount 4 to the boat's gunnel using, for example, three ⅜″ bolts and nuts. The length of these bolts varies depending on how each boat has been manufactured.

More specifically, once marking the hole locations using the mounting plate 4 as a template, the user drills the holes using, for example, a 7/16″ drill bit. The bolts should go through the mounting plate and then the holes the user drilled into the gunnel. Then, the user secures the bolts with nuts on the underside of the gunnel, with, for example, a ⅜″×3″ hex head bolt and nut.

In one embodiment, the trap lift slider 1 slides onto the trap lifter tube 2 prior to its assembly to the trap lifter mount 4.

Once positioned and secured, the user can direct the hook J channel 6 by maneuvering the rotatable and retractable trap lifter tube 2 to align the trap lifter hook J channel 6 with a crawfish trap. The most common type of traps, pyramid traps, have a plastic pipe or cap with a recessed section. Thus, the user would align the J channel 6 with the plastic pipe or cap and hook on to it. Then the trap lifter tube 2 can be rotated to lift the trap out of the water and into the boat. This allows the user to avoid leaning over the edge of the boat and gripping the crawfish trap with their hands.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

1. A trap lifter comprising:
a. a slider connected at one end to a mount and the other end to a lifter tube; and
b. a hook connected to the opposite end of said lifter tube than side slider.

2. The trap lifter of claim 1 wherein said slider is in telescopic communication with said lifter tube.

3. The trap lifter of claim 1 wherein said slider is connected to said mount so as to allow said slider to rotate in a hinged manner around said mount.

4. The trap lifter of claim 1 wherein said hook is connected to said lifter tube with at least two plates.

5. The trap lifter of claim 1 wherein said lifter tube further comprises a handle.

6. The trap lifter of claim 1 wherein said hook comprises a structural piece of J channel

7. The trap lifter of claim 1 wherein said slider, said lifter tube, and said hook mechanism comprise aluminum.

8. A trap lifter comprising:
a. a slider rotatably connected to a mount at one end and telescopically connected to a lifter tube at the other end;
b. a hook connected to the end of said lifter tube opposite said slider;
wherein said mount is connected to a boat so that said hook can be lowered over the side of the boat.

9. The trap lifter of claim 8 wherein said hook is connected to the end of said lifter tube through an elongated connector piece connected perpendicular to said lifter tube, wherein the straight edge of said hook is parallel to said elongated connector piece.

10. The trap lifter of claim 9 wherein said elongated connector piece is connected to said lifter tube with a hinge.
